(19) United States
(12) Patent Application Publication
(10) Pub. No.: US 2026/0302286 A1
(43) Pub. Date: Oct. 1, 2026

(54) SOLID POLYMER FUEL BATTERY ACTIVATION METHOD

(71) Applicant: HONDA MOTOR CO., LTD., Tokyo (JP)

(72) Inventors: Shinsaku Takikawa, Wako-shi (JP); Ryo Mochizuki, Wako-shi (JP); Ken Tagawa, Wako-shi (JP); Takuro Sasaki, Wako-shi (JP)

(21) Appl. No.: 19/550,113

(22) Filed: Feb. 25, 2026

(30) Foreign Application Priority Data
Mar. 28, 2025 (JP) 2025-056249

(51) Int. Cl. H01M 8/04225; H01M 8/04302; H01M 8/04537; H01M 8/04858

(52) U.S. Cl. CPC H01M 8/04225; H01M 8/04302; H01M 8/04582; H01M 8/04932

(57) ABSTRACT

A solid polymer fuel battery activation method is an activation method of a solid polymer fuel battery that includes an anode electrode, a cathode electrode, and a solid polymer membrane arranged between the anode electrode and the cathode electrode, the method including: supplying a mixed gas of an oxidizing gas and an inert gas to the cathode electrode; performing electric power generation while applying a voltage having a predetermined width or less between the cathode electrode and the anode electrode while setting the cathode electrode to be positive by an external electric power source in a state where hydrogen is supplied to the anode electrode; measuring an activity state of a catalyst of a cathode from a value of a current flowing at the electric power generation; and determining completion of activation of the solid polymer fuel battery from a measurement value relating to the activity state.

### CROSS-REFERENCE TO RELATED APPLICATION

Priority is claimed on Japanese Patent Application No. 2025-056249, filed on Mar. 28, 2025, the contents of which are incorporated herein by reference.

### BACKGROUND

### Field of the Invention

The present invention relates to a solid polymer fuel battery activation method.

### BACKGROUND

In the related art, efforts aiming at reduction of the impact on or moderation of climate change have been ongoing, and toward the realization of this purpose, research and development relating to reduction of carbon dioxide emissions has been conducted. From such a viewpoint, a fuel battery vehicle (FCV/Fuel Cell Vehicle) on which a fuel battery is mounted has been attracting attention. This is because the substance discharged from the fuel battery vehicle is only water (H₂O) is, and gases such as CO₂, NOₓ, and SOₓ are not discharged.

In general, a fuel battery mounted on the fuel battery vehicle has a fuel battery stack. The fuel battery stack is obtained by stacking a plurality of fuel battery cells having a flat plate shape. Each fuel battery cell has a membrane electrode assembly (MEA) and a pair of separators arranged on both sides of the membrane electrode assembly.

The membrane electrode assembly includes a solid polymer electrolyte membrane (hereinafter, referred to as an electrolyte membrane) having a first end surface and a second end surface, an anode electrode (fuel electrode) provided on the first end surface of the electrolyte membrane, and a cathode electrode (oxidant electrode) provided on the second end surface of the electrolyte membrane. That is, the membrane electrode assembly has a configuration in which the electrolyte membrane is sandwiched between the anode electrode and the cathode electrode.

In the fuel battery, hydrogen is supplied to the anode electrode of the membrane electrode assembly as an anode gas (fuel). Further, a cathode gas (oxidant) containing oxygen such as air is supplied to the cathode electrode of the membrane electrode assembly. Then, hydrogen ions generated by a reaction between hydrogen and a catalyst at the anode electrode pass through the electrolyte membrane, move to the cathode electrode, cause an electrochemical reaction (O₂+4H⁺+4e⁻→2H₂O) with oxygen in the cathode gas at the cathode electrode, and generate electric power. Accordingly, in each fuel battery cell, water is generated in accordance with the electric power generation.

In the fuel battery, commonly, activation (aging operation) of the fuel battery cell is performed before an operation of the first time. By performing the activation of the fuel battery cell, hydrogen ions and the like can easily move in the fuel battery cell, and a sufficient electric power generation performance can be obtained.

As an activation method of the fuel battery cell, for example, a method is known in which hydrogen is supplied to the anode electrode as an anode gas, and a mixed gas of nitrogen and air is introduced to the cathode electrode as a cathode gas.

Paragraphs 0044 to 0050 of Japanese Unexamined Patent Application, First Publication No. 2016-143621 describe a fuel battery running-in system of determining whether or not a running-in operation is completed based on the amount of an inlet water vapor contained in a gas supplied to a fuel battery and the amount of an outlet water vapor contained in a gas discharged from the fuel battery. Further, paragraphs 0054 to 0063 of Japanese Unexamined Patent Application, First Publication No. 2016-143621 describe that the degree of completion of the running-in of the fuel battery is determined by supplying a humidified gas to the fuel battery and simultaneously applying a load current.

Paragraph 0042 of Japanese Unexamined Patent Application, First Publication No. 2005-243562 describes a fuel battery stabilization determination method in which when the maximum value of a cell voltage is Vmax and the minimum value is Vmin in a specified time T, a fluctuation range VD of a cell voltage value is VD=Vmax−Vmin, it is determined that the state of a fuel battery is stabilized in the case of VD≤VDTh, and it is determined that the state of the fuel battery is not stabilized in the case of VD>VDTh. Paragraph 0066 of Japanese Unexamined Patent Application, First Publication No. 2005-243562 describes a fuel battery stabilization determination method in which an elapsed time from a time measurement start time point to a time point when a voltage value of a cell of the fuel battery exceeds a range of a specified voltage V is defined as a voltage range deviation time Tleft, it is determined that the state of the fuel battery is stabilized in the case of Tleft≥TDTh, and it is determined that the state of the fuel battery is not stabilized in the case of Tleft<TDTh. Paragraph 0087 of Japanese Unexamined Patent Application, First Publication No. 2005-243562 describes a fuel battery stabilization determination method which determines stabilization of the state of the fuel battery at a time point when a cell voltage value reaches a clear condition TDTh without deviating from the range of the specified voltage V.

Claims of Japanese Unexamined Patent Application, First Publication No. 2005-251396 describe a fuel battery operation method of repeatedly performing a step of increasing or decreasing an output current of a fuel battery until a predetermined aging end condition is satisfied.

Claims of Japanese Unexamined Patent Application, First Publication No. 2022-150135 describe a fuel battery aging method which includes a first pattern in which by supplying a humidified hydrogen gas to one electrode among a pair of electrodes and supplying a humidified inert gas to another electrode among the pair of electrodes, protons are moved from the one electrode to the other electrode through an electrolyte membrane and a second pattern in which by supplying the humidified inert gas to the one electrode and supplying the humidified hydrogen gas to the other electrode, protons are moved from the other electrode to the one electrode through the electrolyte membrane.

Paragraph 0016 to 0017 of Japanese Unexamined Patent Application, First Publication No. 2020-161427 describe an aging method of performing electric power generation under a predetermined condition in a state where an over-humidified oxidant is supplied to a cathode side of a solid polymer fuel battery stack. Further, it is described that it is preferable that the aging is performed in a state where an average cell voltage is near zero V, and as a method of obtaining such a state, (a) a method of physically short-circuiting both electrodes with a conductive material and (b) a method of controlling a current and a voltage by using a charge-discharge device and reproducing a state close to a short circuit are described.

Claims of Japanese Unexamined Patent Application, First Publication No. 2020-47560 describe a method of having a potential cycle in which an OCV and the lowest cell potential in load application are repeated between a fuel electrode and an oxidant electrode, wherein in the potential cycle, a fuel gas is supplied to the fuel electrode and an oxidant gas and a carbon monoxide gas are supplied to the oxidant electrode. Further, claims of Japanese Unexamined Patent Application, First Publication No. 2020-47560 describe that the oxidant gas and the carbon monoxide gas are supplied to the oxidant electrode at the time of the load application in the potential cycle, and the oxidant gas is supplied to the oxidant electrode at the time of the load stoppage in the potential cycle. Further, claims of Japanese Unexamined Patent Application, First Publication No. 2020-47560 describe that a nitrogen gas is further supplied to the oxidant electrode, a cell temperature of the fuel battery is 70 to 90° C., the lowest cell potential in the load application is −0.1 V to 0.4 V, the OCV is 0.8 V to 1.1 V, and a displacement velocity of the potential from the lowest cell potential in the load application to the OCV and a displacement velocity of the potential from the OCV to the lowest cell potential in the load application are 0.4 V/sec to 1.0 V/sec.

Claims of Japanese Unexamined Patent Application, First Publication No. 2019-128976 describe a fuel battery aging method of periodically changing the flow rate of an inert gas mixed in an oxidant gas supplied to a cathode and thereby periodically changing a potential of a fuel battery in a range of 0.4 V or less.

Claims of Japanese Unexamined Patent Application, First Publication No. 2019-114336 describe a solid polymer fuel battery aging method that includes a first step of increasing a load current value to a predetermined value, a second step of changing a stoichiometric ratio of a cathode fuel to a predetermined ratio after the first step, and a third step of increasing an inert gas mix amount into the cathode fuel to a predetermined amount after the second step.

### SUMMARY

In the fuel battery activation method of the related art, after a fuel battery is activated, electric power generation of the fuel battery is performed with a high-density current, and when an output at that time is measured, and the output exceeds a predetermined value, it is determined that the activation of the fuel battery is completed. When the output of the fuel battery does not exceed the predetermined value, it is necessary to perform the activation of the fuel battery again. In the method of the related art, it is necessary to directly measure the output with expensive and highly functional equipment in order to determine the completion of the activation of the fuel battery.

An aspect of the present invention aims at providing a solid polymer fuel battery activation method that can easily determine completion of activation of a fuel battery without using expensive and highly functional equipment when the fuel battery is activated. Further, the aspect of the present invention contributes to energy efficiency.

A first aspect of the present invention is a solid polymer fuel battery activation method which is an activation method of a solid polymer fuel battery that includes an anode electrode, a cathode electrode, and a solid polymer membrane arranged between the anode electrode and the cathode electrode, the solid polymer fuel battery activation method including: supplying a mixed gas of an oxidizing gas and an inert gas to the cathode electrode; performing electric power generation while applying a voltage having a predetermined width or less between the cathode electrode and the anode electrode while setting the cathode electrode to be positive by an external electric power source in a state where hydrogen is supplied to the anode electrode; measuring an activity state of a catalyst of a cathode from a value of a current that flows at a time of the electric power generation; and determining completion of activation of the solid polymer fuel battery from a measurement value relating to the activity state.

According to the first aspect described above, by supplying the mixed gas of the oxidizing gas and the inert gas to the cathode electrode and scanning the voltage that varies within the predetermined width between the cathode electrode and the anode electrode while setting the cathode electrode to be positive, it is possible to perform evaluation of a catalyst activity by using a stable current value at that time and to determine completion of activation of the solid polymer fuel battery.

A second aspect is the solid polymer fuel battery activation method according to the first aspect described above, wherein the voltage may be 0.3 V or less.

According to the second aspect described above, the activation of the solid polymer fuel battery is performed at a low voltage and a low current, and therefore, it is possible to prevent deterioration of the solid polymer fuel battery due to the activation.

According to the aspect of the present invention, it is possible to easily determine completion of activation of a fuel battery without using expensive and highly functional equipment when the fuel battery is activated.

### BRIEF DESCRIPTION OF THE DRAWINGS

FIG. 1 is a cross-sectional view schematically showing a fuel battery cell of a fuel battery that is activated by a solid polymer fuel battery activation method according to an embodiment of the present invention.

### DESCRIPTION OF EMBODIMENTS

Hereinafter, an embodiment of the present invention will be described in detail with reference to the drawings.

### [Solid Polymer Fuel Battery Activation Method]

A solid polymer fuel battery activation method according to an embodiment of the present invention is an activation method of a solid polymer fuel battery that includes an anode electrode, a cathode electrode, and a solid polymer membrane arranged between the anode electrode and the cathode electrode, wherein a mixed gas of an oxidizing gas and an inert gas is supplied to the cathode electrode, electric power generation is performed while applying a voltage having a predetermined width or less between the cathode electrode and the anode electrode while setting the cathode electrode to be positive by an external electric power source in a state where hydrogen is supplied to the anode electrode, an activity state of a catalyst of a cathode is measured from a value of a current that flows at a time of the electric power generation, and completion of activation of the solid polymer fuel battery is determined from a measurement value relating to the activity state.

The solid polymer fuel battery activation method of the present embodiment is a method of activating a plurality of stacked fuel battery cells 30. The plurality of fuel battery cells 30 are connected, for example, in series.

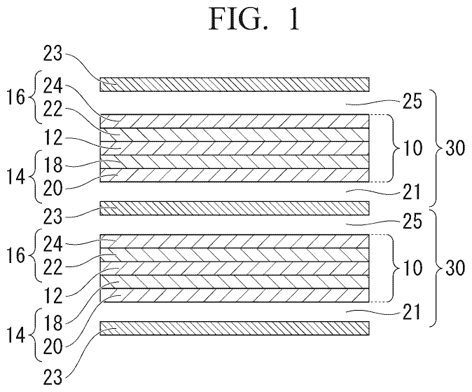

The present embodiment is described using the case where a plurality of fuel battery cells 30 are stacked as an example; however, only one layer of a fuel battery cell 30 may be used. Further, in the case where the fuel battery cells 30 are stacked as shown in FIG. 1, the stack number of fuel battery cells 30 is not particularly limited.

### (Fuel Battery Cell 30)

As shown in FIG. 1, the fuel battery cell 30 (solid polymer fuel battery cell) has a first separator 21, a second separator 25, and a membrane electrode assembly (MEA) 10 arranged between the first separator 21 and the second separator 25.

Each of the first separator 21 and the second separator 25 is made of, for example, a known fuel battery separator such as a metal separator made of stainless steel, aluminum, titanium, or the like, or a carbon separator.

As shown in FIG. 1, the membrane electrode assembly 10 has an anode electrode 14, a cathode electrode 16, and a solid polymer electrolyte membrane 12 (solid polymer membrane) sandwiched between the anode electrode 14 and the cathode electrode 16.

The solid polymer electrolyte membrane 12 is made of an ion exchange membrane having proton conductivity. Specifically, as the solid polymer electrolyte membrane 12, for example, a membrane made of a fluorine system resin such as perfluorosulfonic acid, a hydrocarbon system resin, or the like can be used.

As shown in FIG. 1, the anode electrode 14 has a first electrode catalyst layer 18 and a first gas diffusion layer 20 for supplying a gas to the first electrode catalyst layer 18.

The cathode electrode 16 has a second electrode catalyst layer 22 and a second gas diffusion layer 24 for supplying a gas to the second electrode catalyst layer 22.

As each of the first electrode catalyst layer 18 and the second electrode catalyst layer 22, for example, a layer in which a catalyst is supported by a carrier such as carbon particles or the like can be used. Examples of the catalyst contained in the first electrode catalyst layer 18 and the second electrode catalyst layer 22 include a platinum catalyst, a platinum alloy catalyst made of platinum and another metal, and the like. In the present embodiment, one or both of the first electrode catalyst layer 18 and the second electrode catalyst layer 22 can preferably contain a platinum catalyst. This is because a fuel battery having a sufficient electric power generation performance can be obtained by activating the fuel battery cell 30.

As each of the first gas diffusion layer 20 and the second gas diffusion layer 24, for example, a known fuel battery diffusion layer such as a carbon cloth using a carbon non-woven fabric or a carbon paper can be used.

A cooling water flow path 23 through which cooling water for cooling the fuel battery cell 30 flows is provided between two fuel battery cells 30 that are adjacent to each other.

Next, a solid polymer fuel battery activation method of the present embodiment is described.

The reason why it is necessary to perform activation (aging) of the fuel battery is described. The initial electric power generation performance of a fuel battery is low due to a resistance of an initial dried electrolyte membrane, an oxide film formed on a catalyst in a manufacturing process, and poisoning of the catalyst by a volatile organic substance. Therefore, after the fuel battery is manufactured, in order to obtain a desired electric power generation performance, a preliminary operation (running-in operation) referred to as aging of the fuel battery is usually performed. The aging of the fuel battery is to cause the fuel battery to be able to exhibit a desired performance by wetting the electrolyte membrane, reducing the resistance of the electrolyte membrane, and removing the organic substance and the oxide film on a catalyst surface by preliminarily performing electric power generation of the fuel battery after manufacturing the fuel battery. Further, not only after the manufacturing but also, for example, when electric power generation is performed again (at the time of restart) after pausing of the fuel battery (particularly, after pausing for a long time) or when output characteristics such as an electromotive force are deteriorated by electric power generation for a long time, the output characteristics of the fuel battery may be recovered by performing aging.

The solid polymer fuel battery activation method of the present embodiment has an operation step in which, in a state where a mixed gas of an oxidizing gas and an inert gas is supplied to the cathode electrode and hydrogen is supplied to the anode electrode, electric power generation is performed while applying a voltage having a predetermined width or less between the cathode electrode and the anode electrode while setting the cathode electrode to be positive by an external electric power source, and an activity state of a catalyst of a cathode is measured from a value of a current that flows at that time.

In the mixed gas described above, the mix ratio of the oxidizing gas and the inert gas, that is, the mix ratio of the inert gas to the oxidizing gas can be preferably 1:3.8 in a volume ratio (a volume of the inert gas/a volume of the oxidizing gas), and the stoichiometric ratio can be preferably 1 or more at the minimum. When the mix ratio is less than 1, the catalyst is deteriorated.

The voltage that scans between the cathode electrode and the anode electrode can be preferably 0.3 V or less. When the voltage is equal to or less than the upper limit value, the current that flows through the solid polymer fuel battery becomes equal to or less than 180 mA, and it is possible to prevent deterioration of the solid polymer fuel battery due to activation.

A measurement value indicating the activity state of the catalyst contained in the cathode electrode is obtained, and completion of activation of the solid polymer fuel battery is determined from the measurement value. The measurement value is correlated with electric power generation of a high output, and it is determined that activation of the solid polymer fuel battery is completed by using an arbitrary threshold value.

According to the solid polymer fuel battery activation method of the present embodiment, it is possible to easily determine completion of activation of a fuel battery without using expensive and highly functional equipment when the fuel battery is activated.

Although the embodiment of the present invention has been described in detail, the present invention is not limited to the embodiment described above, and various modifications and changes can be made within the scope of the gist of the present invention described in the claims.

What is claimed is:

1. A solid polymer fuel battery activation method which is an activation method of a solid polymer fuel battery that comprises an anode electrode, a cathode electrode, and a solid polymer membrane arranged between the anode electrode and the cathode electrode, the solid polymer fuel battery activation method comprising:
supplying a mixed gas of an oxidizing gas and an inert gas to the cathode electrode;
performing electric power generation while applying a voltage having a predetermined width or less between the cathode electrode and the anode electrode while setting the cathode electrode to be positive by an external electric power source in a state where hydrogen is supplied to the anode electrode;
measuring an activity state of a catalyst of a cathode from a value of a current that flows at a time of the electric power generation; and
determining completion of activation of the solid polymer fuel battery from a measurement value relating to the activity state.

2. The solid polymer fuel battery activation method according to claim 1, wherein the voltage is 0.3 V or less.
